(19) United States
(12) Patent Application Publication
(10) Pub. No.: US 2009/0179459 A1
(43) Pub. Date: Jul. 16, 2009

(54) DEVICE FOR RETAINING A STRIP IN A CHANNEL

(75) Inventors: Jan Regensburger, Kandern (DE); Günter Tremmel, Schwörstadt (DE)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/376,666

(22) PCT Filed: Jul. 19, 2007
(86) PCT No.: PCT/EP07/06420

§ 371 Date: Feb. 6, 2009

(30) Foreign Application Priority Data
Aug. 23, 2006 (DE) 10-2006-039-577.8

(51) Int. Cl. B60R 13/04

(52) U.S. Cl. 296/191

(57) ABSTRACT

In a device for retaining, in particular, a roof strip (34) in a roof channel (44) of a motor vehicle, a base part (1) and a head part (7) are present. On the base part (1) as well as on the head part (7) a rail arrangement is configured (19, 23), by means of which the head part (7) is displaceably guided with respect to the base part (1) between a pre-assembly position and a final assembly position. Furthermore, a locking arrangement (26, 33; 20, 21) is configured on the head part (7) as well as on the base part (1), by means of which the head part (7) is blocked in the final assembly position in relation to the base part (1) at least for a displacement into the pre-assembly position. Thus, due to the floating mount a simple and reliable connection can be achieved for a roof strip (34), particularly on a motor vehicle, even in the case of relatively large dimensional tolerances of a roof channel (44) and of the roof strip (34) itself.

### CROSS-REFERENCE TO RELATED APPLICATION

This application is a U.S. National Phase Patent Application based on International Application Serial No. PCT/EP2007/006420 filed Jul. 19, 2007, the disclosure of which is hereby explicitly incorporated by reference herein.

### BACKGROUND OF THE INVENTION

1. Field of the Invention

The present invention relates to a device for retaining a strip in a channel, in particular a roof strip in a roof channel of a motor vehicle.

2. Description of the Related Art

One known device is disclosed by DE 10 2005 042 244 A1. The previously disclosed device has a base part that is configured with a retaining structure in the form of sheet metal strips and screws for connection with an engagement structure made in the roof channel. There is also a head part in the form of a flat rail that is equipped with engagement elements in the form of springy clamping arms projecting diagonally outward and shaped lugs to engage with peripheral grooves made on the roof strip. The base part and the head part are positioned rigidly with respect to one another by means of form-fitting and force-fitting connections.

### SUMMARY OF THE INVENTION

The present invention provides a device for retaining a strip in a channel with which, particularly for a motor vehicle, a simple and reliable connection between a strip and the channel can be produced even with relatively large tolerances in the dimensions of a channel and of the strip.

By providing that the base part and the head part are movably guided relative to one another from the pre-assembly position into the final assembled position through the locking system, and in the final assembled position in every case are blocked by the locking system from moving from the final assembled position back into the pre-assembly position, the strip can be aligned relative to the channel in the pre-assembly position with a plurality of devices pursuant to the invention so that when the head part moves relative to the base part into the final assembled position, a continuous correction can be made with tolerances in the dimensions of the strip and/or of the channel that are present under some circumstances, until the head parts are locked and blocked with the base parts.

In one form thereof, the present invention provides a device for retaining a strip in a channel, in particular a roof strip in a roof channel of a motor vehicle, with a base part that is constructed with a retaining structure designed to connect with an engagement structure on the channel, and with a head part that is equipped with engagement elements to engage with peripheral grooves on the strip, characterized by the fact that a rail system is produced on the base part and on the head part with which the head part can be moved with guidance relative to the base part between a pre-assembly position and a final assembled position, wherein the distance between the retaining structure and the engagement elements in the pre-assembly position is greater than in the final assembled position, and there is a locking system on the head part and on the base part with which the head part in the final assembled position is blocked from moving relative to the base part, at least into the pre-assembly position.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 in a first perspective view, an example of embodiment of the invention produced by injection molding, with a base part and a head part, immediately after performing the injection molding process;

FIG. 2 in a second perspective view, the example of embodiment according to FIG. 1;

FIG. 3 the example of embodiment according to FIGS. 1 and 2 in cross section in a pre-assembly position, in engagement with a roof strip and with a roof channel of a motor vehicle;

FIG. 4 the arrangement according to FIG. 3 after a relative motion of the head part toward the base part, from the pre-assembly position toward a final assembled position; and

FIG. 5 the arrangement according to FIGS. 3 and 4 in the final assembled position of the head part relative to the base part.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

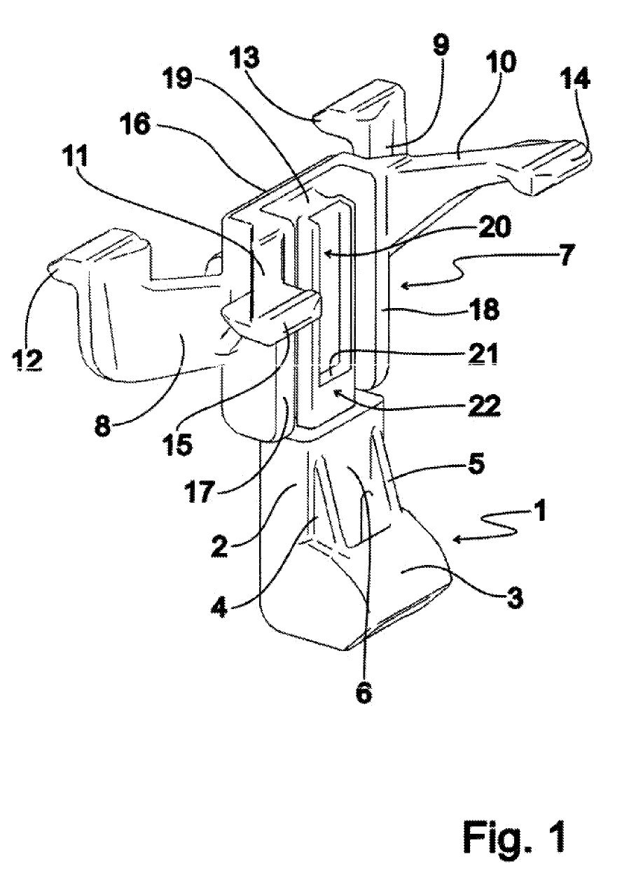

FIG. 1 in a first perspective view shows an example of an embodiment of a device pursuant to the invention that is produced from plastic by injection molding, in an arrangement immediately after concluding the injection molding process, before the injection molding machine is opened. The example of the embodiment in FIG. 1 has a base part 1 that is made with an elongated guide shaft 2 with an essentially rectangular cross section. The guide shaft 2 at one end has a laterally projecting support protrusion 3 as a retaining structure that is contoured, as described in further detail below, to engage in particular with a roof channel of a motor vehicle. There are two shaped webs 4, 5 between the guide shaft 2 and the support protrusion 3 in the form of right-angled triangles, which are molded with their bases on a rear wall 6 of the guide shaft 2, with the hypotenuses of the shaped webs 4, 5 extending between the guide shaft 2 and the support protrusion 3.

The example of the embodiment of FIG. 1 also has an elongated head part 7 with a cross section that is likewise essentially rectangular. Clamping arms 8, 9, 10, 11 are molded on the head part 7 at the four peripheral corners as engaging elements, which extend outward radially and have shaped lugs 12, 13, 14, 15 at their free ends, which are form-fitted to match the contours of peripheral grooves made in a roof strip, as described in further detail below.

The head part 7 has an essentially U-shaped base with a base wall 16 to each of whose peripheral faces a side wall 17, 18 is joined at right angles. A T-shaped inner rail 19 of a rail system is made between the side walls 17, 18, which is connected by its side to the base wall 16. The inner rail 19 on its crossarm facing away from the base wall 16 has a longitudinal groove 20 that is open at one end and is closed at one end with a bumper face 21 of a latching bumper 22.

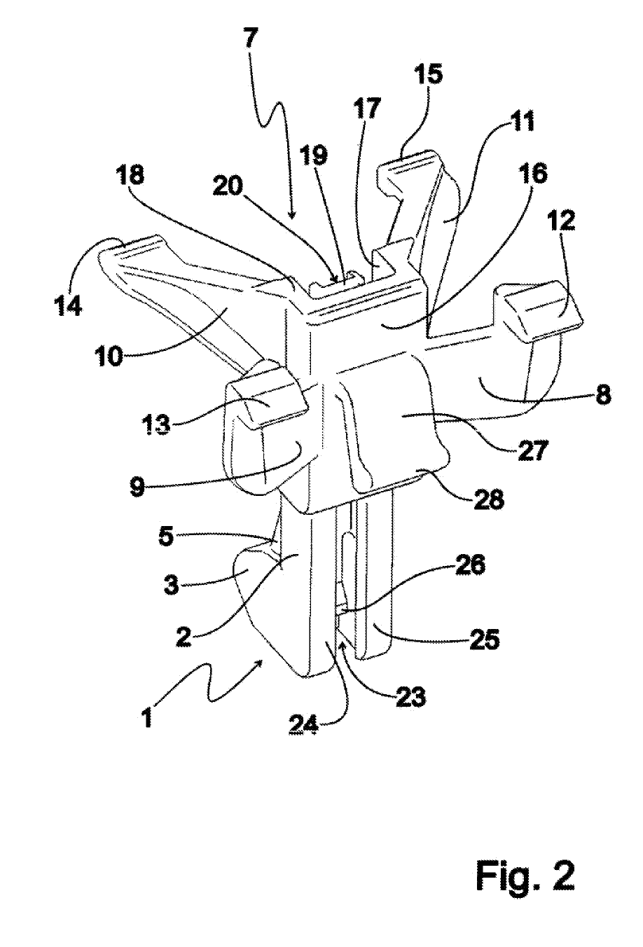

FIG. 2 shows a second perspective view of the example of embodiment of FIG. 1. It can be seen from FIG. 2 that the base part 1 on the face away from the support protrusion 4 of the guide rail 2 has a guide groove 23 made complementary to the inner rail 19 of the head part 7, as another element of the rail system, which is made to grip behind the crossarm of the inner rail 19 with groove walls 24, 25 made to point at one another. The view according to FIG. 2 also shows that the base part 1 has a latching lug 26 that is located in the area of the support protrusion 3 and extends into the guide groove 23.

It can be seen from the illustration according to FIG. 2 that a pressure tab 27 is molded on the base wall 16 of the head part 7 on the face opposite the inner rail 19, which projects at approximately a right angle from the base wall 16 in the molded-on area, extends away from the shaped lugs 12, 13, 14, 15 toward the base part 1, and has a terminal bulge 28 thickened with respect to the remaining cross section of the pressure tab 27 at it free end. This design makes the pressure tab 27 springy toward the base wall 16.

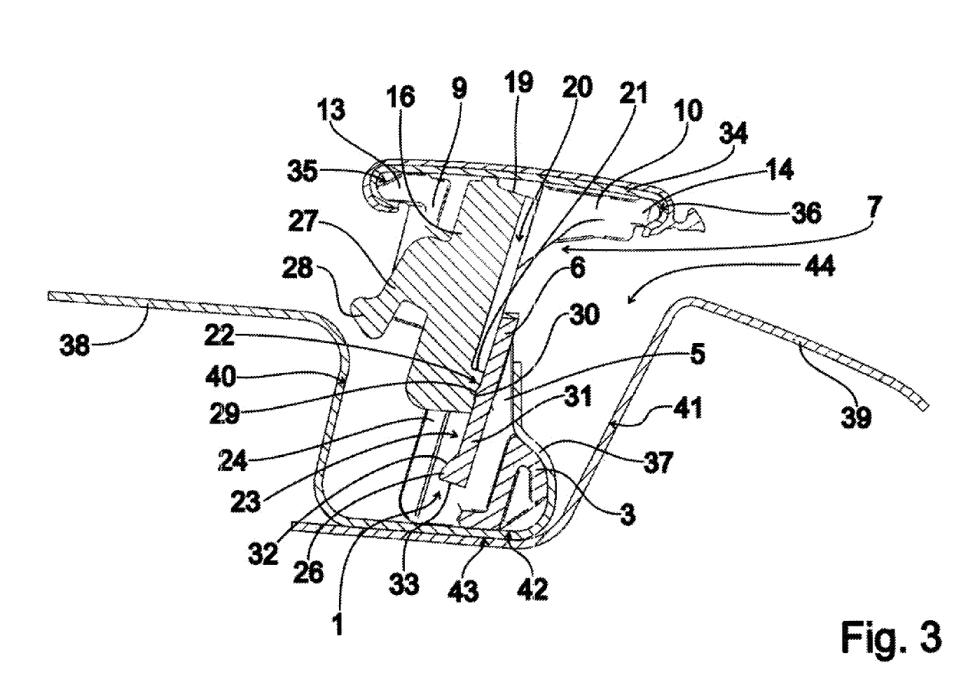

FIG. 3 shows in cross section the example of embodiment of FIG. 1 and FIG. 2 in a pre-assembly position, in which the base part 1 and the head part 7 are in proximity to one another compared to the arrangement according to FIG. 1 and FIG. 2 after ejection from the injection molding machine to the extent that a pre-assembly depression 29 on the inner rail 19 is engaged with a pre-assembly projection 30 in the area of the guide groove 23 on the base part 1. Thus, motion of the head part 7 relative to the base part 1 out of the pre-assembly position meets with some resistance. This pre-assembly position in other respects corresponds to the delivered state, in which each of the clamping arms 8, 9, 10, 11 has an initial distance from the support protrusion 3.

It can be seen in the illustration of FIG. 3 that the latching lug 26 is molded resiliently on a lug tab 31 that is cut free of the rear wall 6 of the base part 1. FIG. 3 also shows that the latching lug 26 on the one hand is designed with a slope 32 on its face away from the support base 2, and with a blocking surface 33 at right angles to the rear wall 6 on its face away from the slope 32.

In the illustration of FIG. 3, the shaped lugs 12, 13, 14, 15 on the clamping arms 8, 9, 10, 11 are engaged with peripheral grooves 35, 36 on a roof strip 34 of a motor vehicle as an example of a strip, wherein tolerances in the distance between the peripheral grooves 35, 36 can be compensated for directly because of the flexibility of the clamping arms 8, 9, 10, 11. The base part 1 in turn is engaged with a retaining rim 37 of a first sheet metal component 38 that is bent around, which in combination with a second sheet metal component 39, each with channel side walls 40, 41 parallel to one another and each at a distance from the retaining rim 37 and with superimposed channel bottom walls 42, 43 define a roof channel 44 as an example of a channel. The roof channel 44 in fact does have an essentially constant depth and width in the longitudinal direction, but for manufacturing reasons there are deviations from specifications for these dimensions that must be compensated, so that a visually suitable appearance is provided when the roof strip 34 is inserted into the roof channel 44.

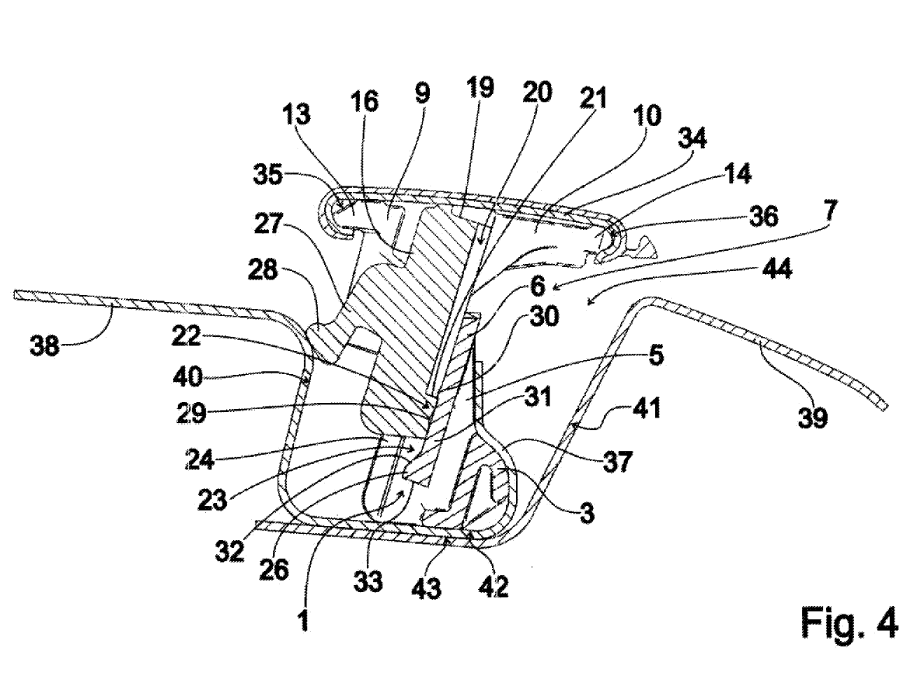

FIG. 4 shows the arrangement according to FIG. 3 after the head part 7 is moved relative to the base part 1, out of the pre-assembly position with the roof strip 36 and the roof channel 46 approaching one another. It can be seen from FIG. 4 that after a given approach of the roof strip 34 to the roof channel 44, the terminal bulge 28 of the pressure tab 27 comes into contact with the channel side wall 40 of the sheet metal component 38 facing it, so that when this motion is continued the pressure tab 27 springs in and the base part 1 presses against the retaining rim 37 with the support protrusion 3 and the shaped webs 4, 5. This produces secure seating of the base part 1 and of the head part 7 in the roof channel 44, since the support protrusion 3 is bent back toward the channel side wall 40 and grips behind an area of the retaining rim 37 constituting an undercut.

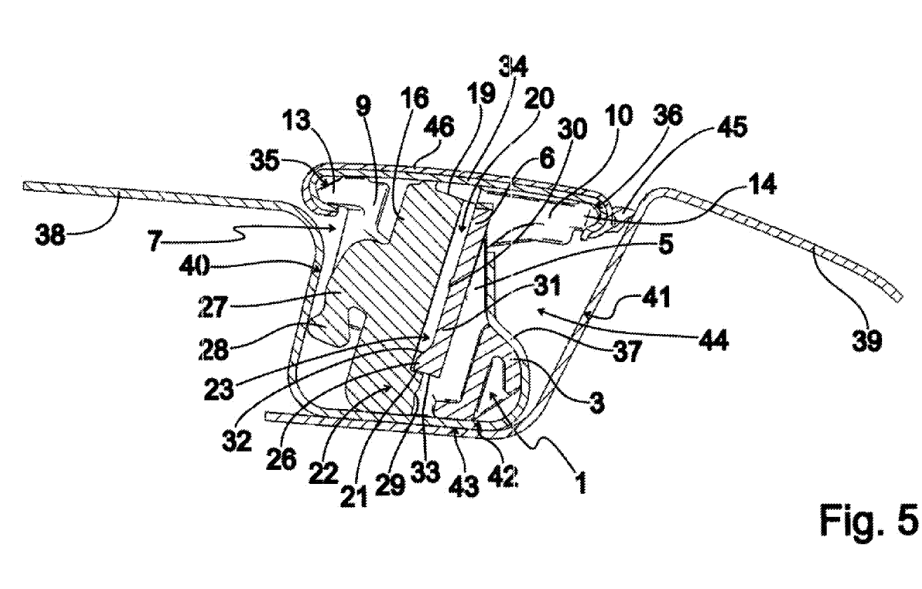

FIG. 5 shows the arrangement according to FIG. 3 and FIG. 4, with the base part 1 and the head part 7 in a final assembled position in which the second distances between the support protrusion 3 and the shaped lugs 12, 13, 14, 15 are smaller than the initial distances in the pre-assembly position, and the blocking surface 33 made on the latching lug 26 grips behind the bumper face 21 defining the longitudinal groove 20. In the final assembled position, the roof strip 34 is positioned at a definite distance from the base part 1 with compensation for tolerances in the distances between the channel side walls 40, 41, and closes off the roof channel 44 at the side opposite the channel bottom walls 42, 43. It is especially readily seen from FIG. 5 that because of the deformation of the pressure tab 27, the base part 1 is brought into intimate contact with the retaining rim 37. The illustration of FIG. 5 also shows that because of the flexibility of the clamping arms 8, 9, 10, 11, not only can tolerances in the distance between the peripheral grooves 35, 36 of the roof strip 34 be compensated for, but also the roof strip 34 can thereby be adapted to some degree overall in the manner of a floating mount, perpendicular to the longitudinal direction of the roof channel 44, to compensate for a slightly curved shape of the roof channel 44.

To provide a seal for the roof channel 44, the roof strip 34 has at least one flexible sealing lip 45, projecting along a peripheral groove 35, 36 toward a channel side wall 40, 41, that is part of a covering 46 of the roof strip 34.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-6. (canceled)

7. A device for retaining a strip in a channel, such as a roof strip in a roof channel of a motor vehicle, in which the channel includes engagement structure and the roof strip includes peripheral grooves, said device comprising:
a base part including a retaining structure connectable with the engagement structure on the channel;
a head part including engagement elements engageable with the peripheral grooves of the strip;
a rail system connecting said base part and said head part and via which said head part is guideably moveable relative to said base part between a pre-assembly position and a final assembled position, with a distance between said retaining structure and said engagement elements in said pre-assembly position greater than in said final assembled position; and
a locking system on said head part and on said base part via which said head part in said final assembled position is blocked from moving relative to said base part from said final assembled position toward said pre-assembly position.

8. The device of claim 7, wherein said engagement elements include a plurality of spring clamping arms that extend laterally beyond said head part at an angle away from one another, said arms having shaped lugs on their ends.

9. The device of claim 7, wherein said retaining structure includes a support protrusion.

10. The device of claim 7, wherein said rail system includes a guide groove on said base part and an inner rail on said head part, said inner rail complementary to said guide groove.

11. The device of claim 7, wherein said locking system includes a latching lug and a latching bumper, with a blocking surface of said latching lug in said final assembled position resting against a bumper face of said latching bumper.

12. The device of claim 7, wherein a spring pressure tab is provided on said head part, said pressure tab acting at a right angle to the relative direction of motion of said base part and said head part and at a right angle to the extent of the strip.
